(19) United States
(12) Patent Application Publication
(10) Pub. No.: US 2006/0117328 A1
(43) Pub. Date: Jun. 1, 2006

(54) Disk drive equipped with tray

(76) Inventor: Kenji Sakano, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 11/288,253

(22) Filed: Nov. 29, 2005

(30) Foreign Application Priority Data
Nov. 30, 2004 (JP) 2004-345805

(51) Int. Cl. G11B 17/04; G11B 33/02; G11B 17/03

(52) U.S. Cl. 720/605

(57) ABSTRACT

In order to provide to provide a disk drive equipped with a tray having a rear end central portion increased in strength without incurring increases in the dimensions of the disk drive, the tray is provided with ribs standing upright on the rear end portion of the tray and extending in a forward-and-rearward direction. Inclined surfaces are formed at the front and rear ends of the ribs so that the ribs push up a clamper when the ribs pass across a position of the clamper.

### BACKGROUND OF THE INVENTION

1. Field of the Invention

The present invention relates to a disk drive equipped with a tray to convey a disk, and more particularly, to a disk drive having a tray reinforced to prevent the tray from being deformed or damaged.

2. Related Art

In a disk drive equipped with a tray, the dimensions of the disk drive, especially the thickness wise or height wise dimension, are increased due to equipping the tray. Accordingly, it has been tried to reduce the thickness of the tray as much as possible. However, if the tray is thinned excessively, the strength and rigidity of the tray decrease. Consequently, the thickness wise dimension has been determined taking account of the balance with the strength and rigidity.

As shown in FIGS. 8A-8C, a tray 1 equipped in a conventional disk drive is substantially rectangular, and has concentrically formed circular recesses 2a and 2b on the upper surface to set a disk. A substantially rectangular opening 3 is formed at the central portion. Guide grooves 4a and 4b extending in the forward-rearward direction are formed on both sides of the bottom surface of the tray. A rack 5 meshing with a pinion is provided to the bottom surface. A rear end central portion of the tray is thinned and formed a step to make the upper surface lower.

The position of the upper surface is lowered by forming the step to prevent interference with a clamper cooperating with a turntable to hold a disk therebetween and rotating, when the tray is conveyed. Such a step is formed in the center of the rear end portion of the tray. However, it is impossible to form reinforcing ribs thereto because the clamper is located on the upper side and the turntable is located on the lower side. Accordingly, the strength of the rear end central portion is low, even if the other portions of the tray are sufficient in strength and rigidity. Consequently, the strength of the tray is low as a whole and thus a warp occurs in the tray.

JP-A-10-275390 discloses “Disk driving device provided with disk tray” movably provided with a disk clamper displacement means mounted on the disk tray, which structured to touch and displace the disk clamper upward not to hinder movement of the disk tray when the tray moves from the disk reproducing position to the disk loading/unloading position, in order to prevent its warp by enhancing the strength.

The disk clamper displacement means has an inclined surface and a horizontal reinforcing portion formed on the rear portion of the disk tray. Consequently, the disk clamper does not hinder movement of the disk tray. Since the reinforcing ribs is formed on the rear sides of the inclined surface and reinforcing portion, the strength of the disk tray is increased, and occurrence of warp to the disk tray is prevented.

However, the bottom surface of the disk clamper abuts against the disk clamper displacement means and is pushed up a large amount. Therefore, the height wise dimension of the disk drive is increased accordingly. Furthermore, when the disk tray is conveyed out into the disk exchange position, the disk clamper sits on the horizontal reinforcing portion of the disk clamper displacement means. That is, the disk tray is lengthened by an amount sufficient to prevent the rear end portion of the tray from disconnecting from the disk clamper. As a result, the lengthwise dimension (depth wise dimension) of the whole disk drive is increased, making it difficult to achieve a compact disk drive.

### SUMMARY OF THE INVENTION

The present invention is to solve such problems in the prior art technique. It is an object of the invention to provide a disk drive, which is equipped with a tray having a rear end central portion increased in strength without incurring increases in the dimensions of the disk drive.

A disk drive according the present invention includes a tray reciprocating between a disk exchange position and a disk reproducing position, a traverse unit equipped with a turntable and being rotatable around a rear end, and a clamper placed opposite to the turntable ascending at the disk reproducing position to hold a disk between the turntable, wherein the tray has ribs standing upright on a rear end portion and extending in a forward-and-rearward direction, the ribs having inclined surfaces at front and rear ends thereof, so that the ribs push up the clamper when the ribs pass across a position of the clamper.

Preferably, the ribs on the rear end portion of the tray are two in number spaced a predetermined distance each other, and disposed to abut against a presser plate of the clamper at outer-peripheral portion. This can minimize the amount by which the clamper is pushed up. Furthermore, the tray is preferably so made its length that the ribs are spaced from the clamper when the tray is conveyed out into the disk exchange position.

According to the disk drive of the invention, the strength of the rear end central portion of the tray can be increased by forming the ribs without incurring increases in the dimensions of the disk drive. Furthermore, the inclined surfaces formed at the front and rear ends of each rib smoothly push up the clamper. The clamper also descends by its own weight. Accordingly, the strength of the whole tray is kept at balance. This prevents the tray from warping.

### BRIEF DESCRIPTION OF THE DRAWING

FIG. 1 is a plan view showing a tray forming a part of a disk drive according to an embodiment of the present invention;

FIG. 2 is a cross-sectional view taken along line Y-Y in FIG. 1;

FIG. 3 is a side elevation view showing the tray;

FIG. 4 is a cross-sectional view showing a state of the disk drive in which a clamper sets on the ribs of the rear end portion of the tray;

FIGS. 5A and 5B are a plan view and a side elevation view, respectively, showing the positional relation of the tray in the disk exchange position to the turntable and the clamper;

FIGS. 6A and 6B are a plan view and a side elevation view, respectively, showing the positional relation among the tray, turntable and clamper in which the clamper is pushed up by the ribs of the rear end portion of the tray;

FIGS. 7A and 7B are a plan view and a side elevation view, respectively, showing the positional relation among the tray, turntable and clamper in which the clamper is spaced from the ribs;

FIG. 8A is a plan view showing a tray forming a part of a conventional disk drive;

FIG. 8B is a cross-sectional view taken along line X-X in FIG. 8A, and

FIG. 8C is a side elevation view showing the conventional disk drive.

### DETAILED DESCRIPTION OF PREFERRED EMBODIMENT

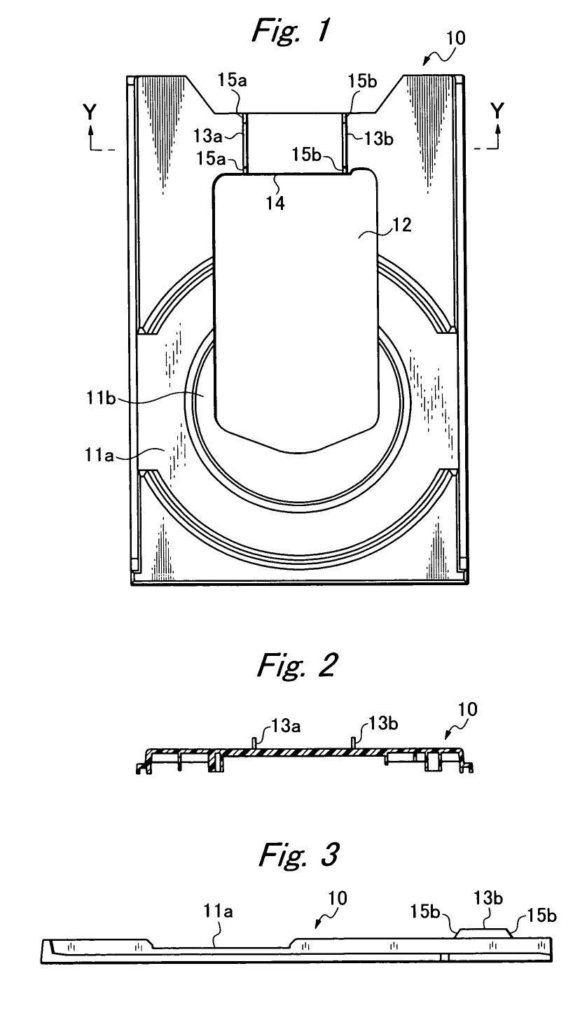

Referring to FIGS. 1-3, a tray 10 forming a part of a disk drive according to an embodiment of the present invention is substantially rectangular in shape. Circular recesses 11a and 11b are formed on the upper surface of the tray to set a disk, and a substantially rectangular opening 12 is formed at the central portion of the tray. The tray also has a rear end portion. Two ribs 13a and 13b stand upright on the rear end central portion, extending in a forward-rearward direction from an edge portion 14 of the opening 12 to the rear end of the tray. The two ribs 13a and 13b are spaced a given distance from each other and extend parallel to each other. Inclined surfaces 15a are formed on the front and rear ends of the rib 13a. Similarly, inclined surfaces 15b are formed on the front and rear ends of the rib 13b.

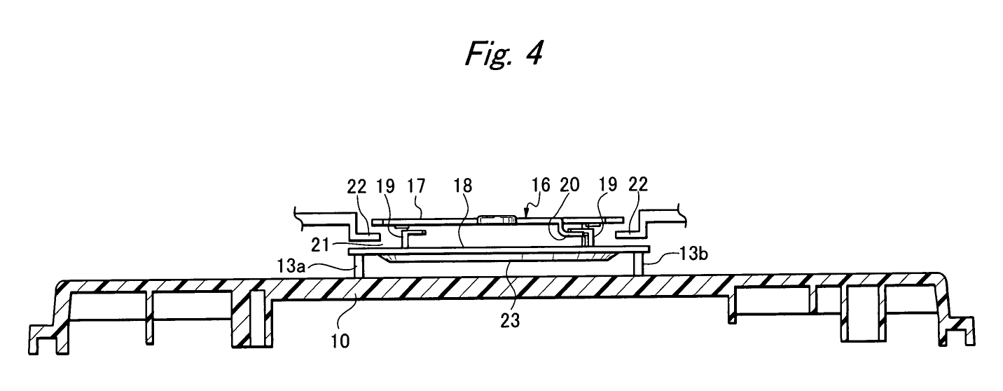

When the tray 10 constructed as above is moving from disk exchange position to disk reproducing position or vice versa, a clamper 16 mounted to a chassis of the disk drive is pushed up by the ribs 13a and 13b of the tray 10, as shown in FIG. 4. The clamper 16 is made up of a circular upper plate 17 and a presser plate 18. L-shaped keys 19 mounted to the presser plate 18 are engaged in their respective engagement elements 20 formed on the upper plate 17. A given space 21 is left between the upper plate 17 and the presser plate 18. The upper plate 17 sits on a clamper support portion 22 of the chassis having an L-shaped cross section and is supported thereon. The clamper support portion 22 also acts to hold the upper plate 17 in position.

A downwardly protruding convex portion 23 is formed in the center of the presser plate 18 of the clamper 16. The outer peripheral portion of the convex portion 23 is inclined and fitted in a hole formed in the center of the disk placed on the turntable 25, thus placing the disk in position. As seen in FIG. 4, the outer peripheral portion of the presser plate 18 sits on the ribs 13a and 13b to be supported thereby, but does not touch the central convex portion 23. That is, the presser plate 18 is pushed up without touching the bottom of the convex portion 23 with the ribs 13a and 13b. Therefore, the ascending distance of the clamper 16 is reduced by an amount equal to the thickness of the convex portion 23. As a result, increase of the height wise dimension of the disk drive can be suppressed.

If the tray 10 moves and the ribs 13a and 13b pass, the clamper 16 descends, and the outer peripheral portion of the upper plate 17 is supported by the clamper support portion 22. When the turntable 25 having the disk carried thereon ascends and pushes up the clamper 16 and the disk is clamped to the clamper 16, the clamper support portion 22 is isolated within the space 21 formed between the upper plate 17 and the presser plate 18. When the clamper 16 rotates with the disk, the clamper does not touch the clamper support portion 22.

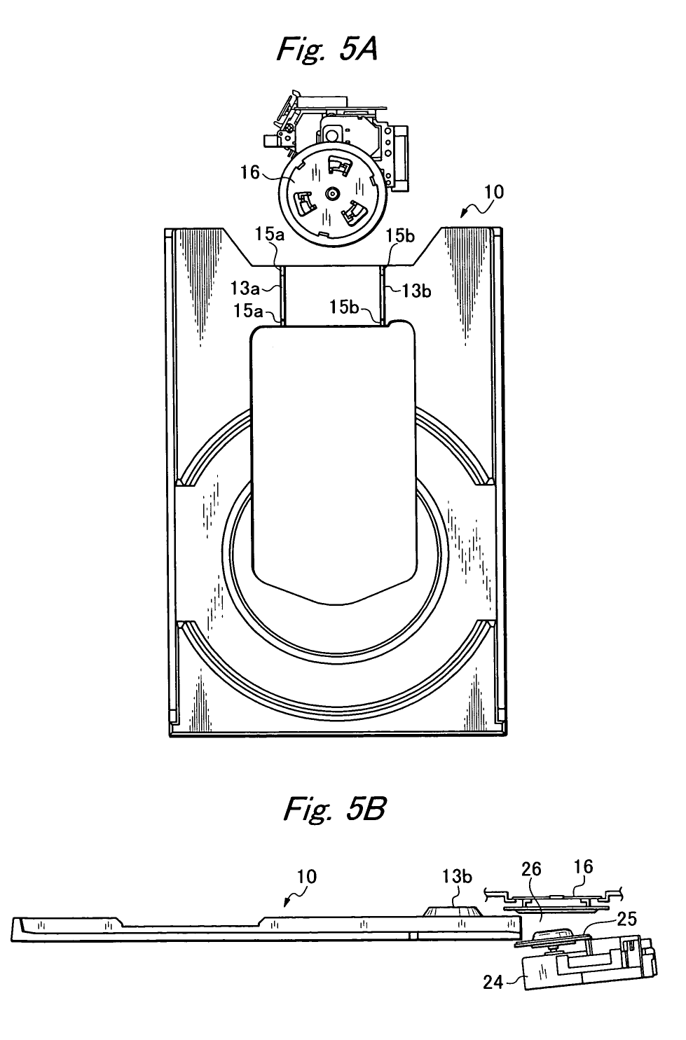

When the tray 10 moves between the disk exchange position and disk reproducing position, positional relationships among the tray 10, turntable 25, and clamper 16 are as shown in FIGS. 5A-7B. That is, when a traverse unit descends, the turntable 25 descends together with the spindle motor 24. The disk held between the turntable 25 and the clamper 16 also descends and is placed onto the tray 10. Then, the disk is conveyed out into the disk exchange position shown in FIGS. 5A and 5B. Where the tray 10 is in the disk exchange position, the spindle motor 24 mounted to the traverse unit, the turntable 25 mounted to the main shaft of the spindle motor 24, and the clamper 16 mounted to the chassis of the disk drive are moved away from the rear end of the tray as shown in FIGS. 5A and 5B. That is, unlike the conventional disk drive of JP-A-10-275390, the tray can be shortened, and the lengthwise dimension of the disk drive is shortened.

Under this condition, the disk can be exchanged. When another disk is set in the circular recess 15a or 15b in the tray 10 and the front end of the tray 10 is pushed, the motor is driven to rotate the pinion. The tray 10 is conveyed into the disk drive together with the rack meshed with the pinion.

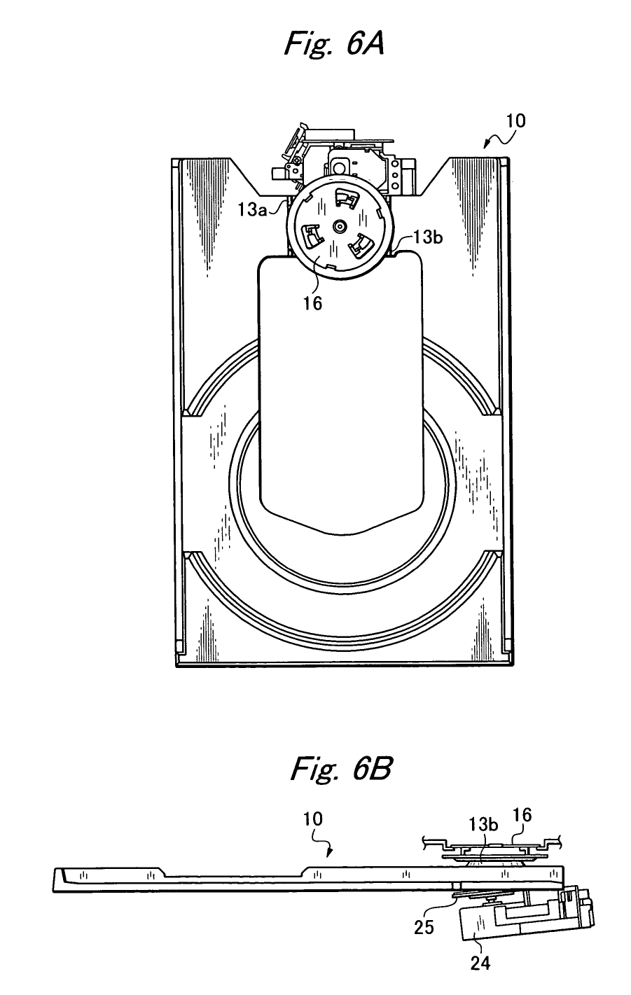

At this time, the tray 10 moves through a slight space 26 left between the turntable 25 and the clamper 16 and is conveyed in toward the reproducing position within the disk drive. When the tray 10 moves in this way, the clamper 16 strikes the ribs 13a and 13b standing upright on the rear end of the tray, whereby the clamper is pushed up. FIGS. 6A and 6B show a state in which the tray 10 has started to carry in a disk and the clamper 16 rides over the ribs 13a and 13b. Under this condition, the turntable 25 has descended to avoid interference with the bottom of the tray 10.

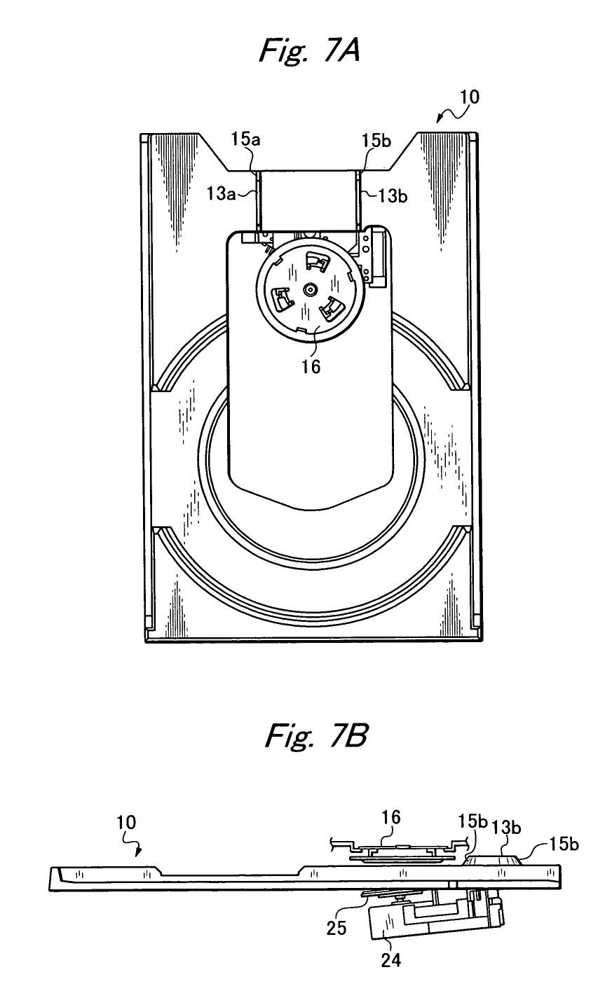

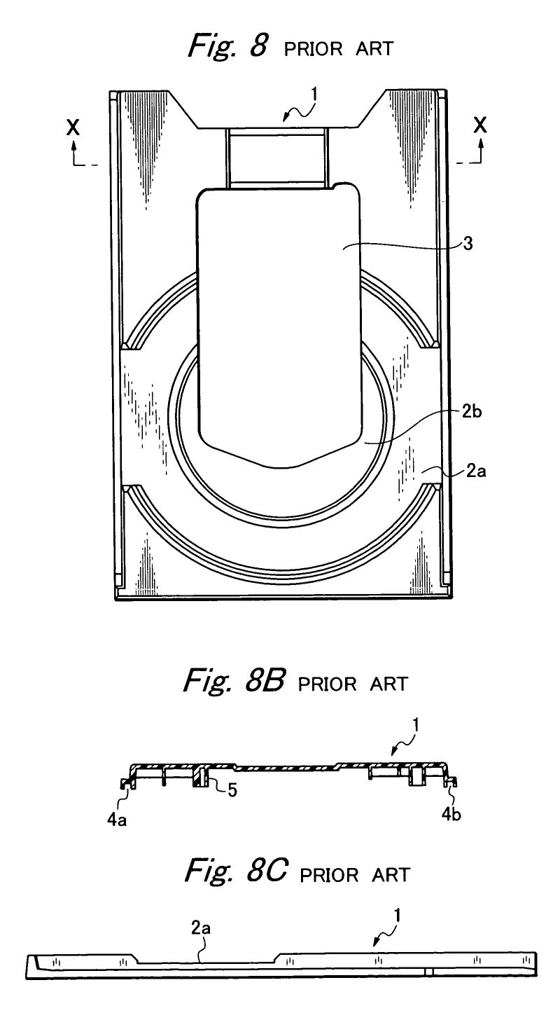

When the clamper 16 is pushed over the ribs 13a and 13b, the clamper abuts against the inclined surfaces 15a and 15b of the rear ends. After the clamper 16 passes across the ribs 13a and 13b, the clamper 16 again descends as shown in FIGS. 7A and 7B. When the clamper 16 reaches the disk reproducing position, the traverse unit ascends. At the same time, the turntable 25 also ascends and the disk is placed on it. The turntable 25 further ascends and the disk is held between the turntable 25 and the clamper 16 and clamped.

1. A disk drive comprising a tray reciprocating between a disk exchange position and a disk reproducing position, a traverse unit equipped with a turntable and being rotatable around a rear end, and a clamper placed opposite to the turntable ascending at the disk reproducing position to hold a disk between the turntable,
wherein the tray has ribs standing upright on a rear end portion and extending in a forward-and-rearward direction, the ribs having inclined surfaces at front and rear ends thereof, so that the ribs push up the clamper when the ribs pass across a position of the clamper.

2. A disk drive according to claim 1, wherein said ribs standing on the rear end portion of the tray are two in number spaced a predetermined distance each other, and disposed to abut against a presser plate of the clamper at outer-peripheral portion.

3. A disk drive according to claim 1, wherein said tray is so made its length that the ribs are spaced from the clamper when the tray is conveyed out into the disk exchange position.

4. A disk drive according to claim 2, wherein said tray is so made its length that the ribs are spaced from the clamper when the tray is conveyed out into the disk exchange position.
